(19) United States
(12) Patent Application Publication
(10) Pub. No.: US 2012/0141279 A1
(43) Pub. Date: Jun. 7, 2012

(54) DRAG-TYPE WIND TURBINE FOR WIND-DRIVEN ELECTRICITY GENERATORS AND WIND-DRIVEN ELECTRICITY GENERATORS USING DRAG-TYPE WIND TURBINE

(75) Inventor: Eiichi YASUI, Mie Pref. (JP)

(73) Assignee: Maruyoshi Shokai Co., ltd., Mie Pref. (JP)

(21) Appl. No.: 13/308,603

(22) Filed: Dec. 1, 2011

(30) Foreign Application Priority Data
Dec. 1, 2010 (JP) 2010-268829

(51) Int. Cl. F03D 3/06; F03D 11/02

(52) U.S. Cl. 416/170 R; 416/178

(57) ABSTRACT

Drag-type wind turbine blades for wind-driven electricity generators are vertically provided between plates of the generator. The wind turbine blades have a plate-like structure with a fin-shaped surface. The turbine blade comprises a wind receiving side consisting of a base section, a base concave-shaped wind receiving section, a convex-shaped wind streaming section, and a wind streaming side of a convex-shaped surface extending in a radiation direction on the back of the wind receiving side. The base end of the wind receiving side and the connecting side comprise an inverse parabolic concave-shaped connecting section to connect it to the base section of the wind streaming side.

### FIELD OF INVENTION

This invention relates to drag-type wind turbine blades used in wind-driven electricity generators and wind-driven electricity generators using drag-type wind turbine blades.

### BACKGROUND OF THE INVENTION

As is well known, wind-driven electricity generators (wind-power generation) using rotary blades (vanes, turbine blades or the like) attract much attention since they require no natural resources and emit no CO2 (carbon dioxide). Wind-driven electricity generators using rotary blades are generally known as drag-type rotary blades and lift-type rotary blades. Each has its advantages and disadvantages. The advantages of the drag-type rotary blades are that its sails require less wind to make much electricity without emitting noise or low-frequency waves. The disadvantages of both the drag-type and lift-type rotary blades are that they do not always get enough wind to rotate them, and they pose a risk to human health by their emission of noise and low-frequency waves. There is also the risk of handling them during natural disasters, for example, in typhoon rains and strong winds. They also mar any beautiful scenery near them.

The prior arts as described below have fewer advantages than this invention.

The prior art \textcircled{1}, as described in publication WO2007-141834, entitled, “Blades for the Wind Wheel, the Wind Wheel and the Wind-Driven Electricity Generator” refers to the structure of a windmill having a plurality of joists that pass through each of three pillars spaced apart at a certain distance, with a windmill-shaped blade plate being placed on the joists. Within this structure, three plate-like blades of a bulging fin-shaped face are spaced equally apart, with an air passages being provided between the blades and a wind-power rotary windmill being used as an electric motor. The invention seems to have a basic structure, of which the concave area of each blade having a bulging fin-shaped face effectively receives the wind to generate electricity surely and efficiently, and which lets the used wind emit smoothly so as to protect the blades from being damaged.

The prior art \textcircled{2}, as described in the published Japanese unexamined patent application No. 2007-332871, relates to an invention of “a bladed wheel for a windmill,” a structure of which circular plates are supportively provided on the top and bottom of its rotary shaft, for example, of a savonius wind turbine having three or four blades provided between circular plates provided at the top and bottom of its rotary shaft. Also, wind passages are provided between the blades to receive the wind on the concave part of the blades, with the wind being discharged through the wind passages. This feature seems similar to that of prior art \textcircled{1}.

The prior art \textcircled{3}, as described in the published Japanese unexamined patent application No. 2006-46306, relates to an invention of “a windmill for a wind-driven electricity generator and its drive system,” a structure of which a plurality of supporting bars being provided on the top and bottom portion of a rotary shaft, with many supporting anchors being provided on the circumference of its rotary shaft, and with savonius turbine blades being provided vertically on the supporting anchor, with wind passages being provided at the base end (rotary-shaft side) of the blades to receive wind on the concave part of the blades, with the wind being discharged through the wind passages. This feature seems similar to that of prior art \textcircled{1}.

The prior art \textcircled{4}, as described in the published Japanese unexamined patent application No. 2002-106458, relates to an invention of a “vertical-type of a wind-power apparatus with three blades,” having a structure of which a vertical shaft is provided on the bottom (base) plate, with blades of a convex-shaped surface provided at regular intervals to make space for the passages for the wind, with a spring being provided to connect the blades to the vertical shaft to adjust for the centrifugal force caused by the rotation of the shaft and of the pressure of wind against the blades, thus securing the appropriate position of the blades to receive the wind on the concave part of the blades, with the used wind being discharged through wind passages. This feature seems similar to that of prior art \textcircled{1}.
Patent Document \textcircled{1}: WO2007-141834
Patent Document \textcircled{2}: Japanese published unexamined patent application No. JP2007-332871
Patent Document \textcircled{3}: Japanese published unexamined patent application No. JP2006-46306
Patent Document \textcircled{4}: Japanese published unexamined patent application No. JP2002-106458

### SUMMARY OF THE INVENTION

### Problems to be Solved by the Invention

The aforementioned publications \textcircled{1} to \textcircled{4} seemingly have in common a basic structure to receive wind by means of a concave part of the blades having bulging fin-shaped face, vanes, blades or the like (hereinafter called, turbine blades) to generate electricity efficiently and to discharge smoothly the used wind to protect the blades from being damaged.

However, the above inventions are only of structures of which wind is received by just a certain part of the wind-receiving surface consisting of concave section, sunken section, or the like of the fin-shaped blades. Just as wind is being received on the wind-receiving surface, it is directly discharged through the wind passages.

Thus, wind is not efficiently used by any of the above structures, so there is still room for improving the drag-type blades used to generate electricity. Also, such blades of these structures only temporarily receive the natural wind, thus not fully using but wasting the wind, and thus not economically using wind power.

The intention of the first aspect of this invention is to receive wind by wind turbine blades so that wind received upon the blades makes a whirling jet of air (whirling current) to be a weir thus increasing the wind power upon a concave-shaped section that is receiving the wind, thus using efficiently wind power or the like. The first aspect of this invention also intends to stream wind upon the convex surface of the blades, and to stream such wind upon the concave-shaped section of the blades that are receiving the wind, thus using efficiently the wind streaming along the convex-shaped section of the blades. Thus, the first aspect of this invention makes it possible for the wind to stay longer upon the wind turbine blades, thus almost fully using and not wasting the natural wind, thus providing drag-type wind turbine blades for wind-driven electric power generators, thus economically using the wind power.

The first aspect of this invention refers to drag-type wind turbine blades for a wind-driven electricity generator, which are vertically provided between at least two plates provided in the air of which the wind turbine blades of a plate-like structure and a fin-shaped surface comprising a wind receiving side to receive wind, and a wind streaming side located on the back of the wind receiving side, and a base end of the wind receiving side and a connecting side to connect the base end of the wind streaming side, characterized in that the wind receiving side comprises a base section, and a base concave-shaped wind receiving section that is sunken at a sharp angle from the free end of the base section, and an concave-shaped wind receiving section in the shape of an inverse parabola extending in the radiation direction, and the wind streaming side has a convex-shaped wind streaming section that is gently formed in the shape of a parabola extending from the base section toward the end of the radiation direction, and the connecting side comprises a concave-shaped connecting section in the shape of an inverse parabola extending toward both base ends.

The intention of the second aspect of this invention is to achieve the first aspect of this invention and to provide examples of the most appropriate concave condition of the turbine blades, of the concave-shaped wind receiving section, and of the convex-shaped wind receiving section.

The second aspect of this invention also refers to drag-type wind turbine blades for a wind-driven electricity generator, according to the first aspect of this invention, characterized in that a concave condition of the base concave-shaped wind receiving section of the blades, a caving direction of the concave-shape wind receiving section and a bulging direction of the convex-shaped wind receiving section of the blades are determined based on reference line A provided on the top surface of the wind turbine blade.

The intention of the third aspect of this invention is to achieve the first aspect of this invention and to provide examples of the most appropriate concave-shaped connecting section of the blades.

The third aspect of this invention further refers to drag-type wind turbine blades for a wind-driven electricity generator according to the first aspect of this invention, characterized in that a caving direction of the concave-shaped connecting section of the blades is determined based on reference line B provided between the base ends of the wind receiving side and of the wind streaming side.

The intention of the fourth aspect of this invention is to receive the wind by a plurality of the wind turbine blades vertically provided, so that the wind received upon the blades makes a whirling jet of air (whirling current) to be a weir thus increasing the wind power upon a concave-shaped section for receiving the wind, thus using efficiently the wind power or the like, thus providing a structure of which even a slight wind makes it possible to generate electricity the year round by rotating wind turbine blades. Also, the intention of the fourth aspect of this invention is to stream such wind through a convex-shaped wind streaming section by a whirling jet of air (whirling current) generated by the blades and to stream such wind upon the concave-shaped wind receiving section to economically use the wind streaming through the convex-shaped wind streaming section, thus efficiently generating electricity. The intention of the fourth aspect of this invention is to make it possible for the wind to stay longer upon the turbine blades, thus almost fully using, not wasting the natural wind, and eventually providing a wind-driven electricity, thus economically using wind power.

The fourth aspect of this invention refers to a wind-driven electricity generator having an outer framework of which a plurality of pillars are vertically provided on the base, with joists being provided at the top and bottom on the pillars at a certain distance apart, and a main shaft being supportively provided by a bearing on the bottom joist whilst a countershaft is supportively provided by a bearing, characterized in that a top and bottom plate are respectively provided on the main shaft and countershaft, and between them a plurality of plate-like wind turbine blades of a fin-shaped surface, integrally comprising a wind receiving side to receive the wind, and a wind streaming side located on the back of the wind receiving side, and a base end of the wind receiving side and a connecting side to connect the base end of the wind streaming side, are vertically provided, wherein wind passages (1 to n) are provided in a space formed by a certain part of the peripheral wall consisting of the wind receiving side and connecting side of the first to nth turbine blades and a certain part of the peripheral wall consisting of the wind receiving side and connecting side of the fourth to nth turbine blades and in a space formed by an entire peripheral wall consisting of the wind receiving side and the wind streaming side and the connecting side of the second to nth turbine blades and an entire peripheral wall consisting of the wind receiving side and the wind streaming side and the connecting side of the third to nth turbine blades.

The intention of the fifth aspect of this invention is to achieve the fourth aspect of this invention and to maximize the rotation of the wind turbine blades to increase the production of electricity.

The fifth aspect of this invention refers to a wind-driven electricity generator according to the fourth aspect of this invention, characterized in that a large pulley is attached to a main shaft, with a belt fitted on the large pulley to connect it to a deputy pulley, and with a belt fitted on the deputy pulley to connect it to a small pulley provided on the input axis of the generator.

The intention of the sixth aspect of this invention is to achieve the fourth aspect of this invention and to provide a structure of turbine blades that most appropriately achieves the intention of the fourth aspect of this invention.

The sixth aspect of this invention refers to a wind-driven electricity generator according to the fourth aspect of this invention, characterized in that a middle plate is provided between the top plate and the bottom plate, wherein a plurality of bottom wind turbine blades and wind passages are provided between the bottom plate and the middle plate, and a plurality of top wind turbine blades and wind passages are provided between the middle plate and the top plate.

The intention of the seventh aspect of this invention is to achieve the fourth aspect of this invention to provide a pair of wind turbine blades in a different rotational phase to achieve most appropriately the intention of the fourth aspect of this invention.

The seventh aspect of this invention refers to a wind-driven electricity generator according to the sixth aspect of this invention, characterized in that a plurality of top and bottom wind turbine blades and respective wind passages are provided between the top and bottom and a middle plates, wherein the top and bottom wind turbine blades and wind passages are in different rotational phase.

The intention of the eighth aspect of this invention is to achieve the fourth aspect of this invention and to provide a top, middle and bottom plate and a structure of top and bottom wind turbine blades to achieve most appropriately the intention of the fourth aspect of the invention.

The eighth aspect of this invention refers to a wind-driven electricity generator according to the fourth aspect of this invention, characterized in that the top wind turbine blades are supportively hung from top plate, and are connected to bottom wind turbine blades through a middle plate, and bottom wind turbine blades are provided on a bottom plate that is fixed to a main shaft provided on the bottom joist.

### Effect of the Invention

The first aspect of this invention is drag-type wind turbine blades for a wind-driven electricity generator, which are vertically provided between at least two plates provided in the air of which the wind turbine blades of a plate-like structure and a fin-shaped surface comprising a wind receiving side to receive wind, and a wind streaming side located on the back of the wind receiving side, and a base end of the wind receiving side and a connecting side to connect the base end of the wind streaming side, characterized in that the wind receiving side comprises a base section, and a base concave-shaped wind receiving section that is sunken at a sharp angle from the free end of the base section, and an concave-shaped wind receiving section in the shape of an inverse parabola extending in the radiation direction, and the wind streaming side has a convex-shaped wind streaming section that is gently formed in the shape of a parabola extending from the base section toward the end of the radiation direction, and the connecting side comprises a concave-shaped connecting section in the shape of an inverse parabola extending toward both base ends.

Therefore, the first aspect of this invention has a feature to receive wind by wind turbine blades so that wind received upon the blades makes a whirling jet of air (whirling current) to be a weir thus increasing the wind power upon a concave-shaped section that is receiving the wind, thus using efficiently wind power or the like. The first aspect of this invention also has a feature to stream wind upon the convex surface of the blades, and to stream such wind upon the concave-shaped section of the blades that are receiving the wind, thus using efficiently the wind streaming along the convex-shaped section of the blades. Furthermore, the first aspect of this invention has a feature to makes it possible for the wind to stay longer upon the wind turbine blades, thus almost fully using and not wasting the natural wind, thus providing drag-type wind turbine blades for wind-driven electric power generators, thus economically using the wind power.

The second aspect of this invention is also drag-type wind turbine blades for a wind-driven electricity generator, according to the first aspect of this invention, characterized in that a concave condition of the base concave-shaped wind receiving section of the blades, a caving direction of the concave-shape wind receiving section and a bulging direction of the convex-shaped wind receiving section of the blades are determined based on reference line A provided on the top surface of the wind turbine blade.

Therefore, the second aspect of this invention has a feature to achieve the first aspect of this invention and to provide examples of the most appropriate concave condition of the turbine blades, of the concave-shaped wind receiving section, and of the convex-shaped wind receiving section.

The third aspect of this invention is drag-type wind turbine blades for a wind-driven electricity generator according to the first aspect of this invention, characterized in that a caving direction of the concave-shaped connecting section of the blades is determined based on reference line B provided between the base ends of the wind receiving side and of the wind streaming side.

Therefore, the third aspect of this invention has a feature to achieve the first aspect of this invention and to provide examples of the most appropriate concave-shaped connecting section of the blades.

The fourth aspect of this invention is a wind-driven electricity generator having an outer framework of which a plurality of pillars are vertically provided on the base, with joists being provided at the top and bottom on the pillars at a certain distance apart, and a main shaft being supportively provided by a bearing on the bottom joist whilst a countershaft is supportively provided by a bearing, characterized in that a top and bottom plate are respectively provided on the main shaft and countershaft, and between them a plurality of plate-like wind turbine blades of a fin-shaped surface, integrally comprising a wind receiving side to receive the wind, and a wind streaming side located on the back of the wind receiving side, and a base end of the wind receiving side and a connecting side to connect the base end of the wind streaming side, are vertically provided, wherein wind passages (1 to n) are provided in a space formed by a certain part of the peripheral wall consisting of the wind receiving side and connecting side of the first to nth turbine blades and a certain part of the peripheral wall consisting of the wind receiving side and connecting side of the fourth to nth turbine blades and in a space formed by an entire peripheral wall consisting of the wind receiving side and the wind streaming side and the connecting side of the second to nth turbine blades and an entire peripheral wall consisting of the wind receiving side and the wind streaming side and the connecting side of the third to nth turbine blades.

Therefore, the fourth aspect of this invention has a feature to receive the wind by a plurality of the wind turbine blades vertically provided, so that the wind received upon the blades makes a whirling jet of air (whirling current) to be a weir thus increasing the wind power upon a concave-shaped section for receiving the wind, thus using efficiently the wind power or the like, thus providing a structure of which even a slight wind makes it possible to generate electricity the year round by rotating wind turbine blades. Also, the fourth aspect of this invention has a feature to stream such wind through a convex-shaped wind streaming section by a whirling jet of air (whirling current) generated by the blades and to stream such wind upon the concave-shaped wind receiving section to economically use the wind streaming through the convex-shaped wind streaming section, thus efficiently generating electricity. Furthermore, the fourth aspect of this invention has a feature to make it possible for the wind to stay longer upon the turbine blades, thus almost fully using, not wasting the natural wind, and eventually providing a wind-driven electricity, thus economically using wind power.

The fifth aspect of this invention is a wind-driven electricity generator according to the fourth aspect of this invention, characterized in that a large pulley is attached to a main shaft, with a belt fitted on the large pulley to connect it to a deputy pulley, and with a belt fitted on the deputy pulley to connect it to a small pulley provided on the input axis of the generator.

Therefore, the fifth aspect of this invention has a feature to achieve the fourth aspect of this invention and to maximize the rotation of the wind turbine blades to increase the production of electricity.

The sixth aspect of this invention is a wind-driven electricity generator according to the fourth aspect of this invention, characterized in that a middle plate is provided between the top plate and the bottom plate, wherein a plurality of bottom wind turbine blades and wind passages are provided between the bottom plate and the middle plate, and a plurality of top wind turbine blades and wind passages are provided between the middle plate and the top plate.

Therefore, the sixth aspect of this invention has a feature to achieve the fourth aspect of this invention and to provide a structure of turbine blades that most appropriately achieves the intention of the fourth aspect of this invention.

The seventh aspect of this invention is a wind-driven electricity generator according to the sixth aspect of this invention, characterized in that a plurality of top and bottom wind turbine blades and respective wind passages are provided between the top and bottom and a middle plates, wherein the top and bottom wind turbine blades and wind passages are in different rotational phase.

Therefore, the seventh aspect of this invention has a feature to achieve the fourth aspect of this invention to provide a pair of wind turbine blades in a different rotational phase to achieve most appropriately the intention of the fourth aspect of this invention.

The eighth aspect of this invention is a wind-driven electricity generator according to the fourth aspect of this invention, characterized in that the top wind turbine blades are supportively hung from the top plate, the top wind turbine blades are connected to the bottom wind turbine blades through the middle plate, and the bottom wind turbine blades are provided on the bottom plate that is fixed to the main shaft provided on the bottom joist.

Therefore, the eighth aspect of this invention has a feature to achieve the fourth aspect of this invention and to provide a top, middle and bottom plate and a structure of top and bottom wind turbine blades to achieve most appropriately the intention of the fourth aspect of the invention.

### BRIEF DESCRIPTION OF THE DRAWINGS

FIG. 1-1 is the front view of the first embodiment showing the top part of the wind-driven electricity generator duly installed.

FIG. 1-2 is the front view of the first embodiment showing the bottom part of the wind-driven electricity generator duly installed.

FIG. 2 is the front view of the first embodiment showing the turbine blades and the wind-driven electricity generator.

FIG. 3 is the schematic top view of the electricity generator as seen in FIG. 2.

FIG. 4 is the front view of the second embodiment showing the set of turbine blades of the wind-driven electricity generator.

FIG. 5 is the top view of the second embodiment showing the relative positions of the top and bottom turbine blades.

FIG. 6 is the perspective view of a part of one of the turbine blades used in the embodiments of this invention.

FIG. 7-1 is the schematic top view of the first embodiment showing the first example of the turbine blades rotating by wind pushing against them and of the wind exiting.

FIG. 7-2 is the schematic top view of the first embodiment showing the second example of the turbine blades rotating by wind pushing against them and of the wind exiting.

FIG. 7-3 is the schematic top view of the first embodiment showing the third example of the turbine blades rotating by wind pushing against them and of the wind exiting.

FIG. 8-1 is the schematic view of the top end of the second embodiment showing the turbine blades rotating by wind pushing against them and of the wind exiting.

FIG. 8-2 is the schematic view of the bottom end of the second embodiment showing the turbine blades rotating by wind pushing against them and of the wind exiting.

FIG. 9-1 is the perspective view of a part of a turbine blade used in another embodiment.

FIG. 9-2 is the top view of the third embodiment of which the turbine blades of another embodiment, is employed in the second embodiment of FIG. 5. Also, FIG. 9-2 shows the positional relation between the top and bottom wind turbine blades.

FIG. 10 is the exploded view of the second and third embodiments showing the suspension system of the top turbine blades.

FIG. 11-1 is the schematic view of the first embodiment showing the electricity generator installed on the rooftop of a certain building.

FIG. 11-2 is the schematic view of the first embodiment showing the electricity generator installed on the rooftop of a house.

FIG. 11-3 is the schematic view of the first embodiment showing the electricity generator installed in the front yard of a house.

FIG. 11-4 is the schematic view of the first embodiment showing the electricity generator installed near a greenhouse.

FIG. 11-5 is the schematic view of the first embodiment showing four electricity generators standing in a row installed in hilly country.

### DETAILED DESCRIPTION OF THE PREFERRED EMBODIMENTS

The preferred embodiments of the invention are described below.

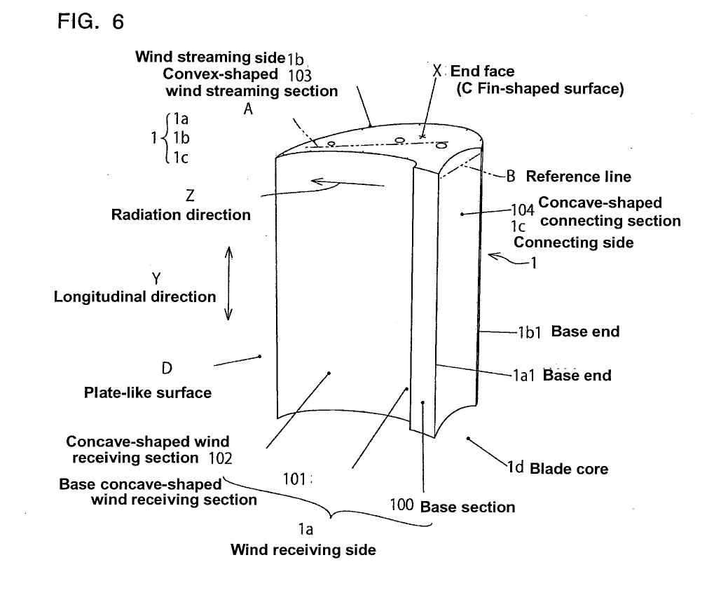

Firstly, (referring to FIG. 6) the overall structure of wind turbine blades 1 that are commonly used for the embodiments in this invention is that end surface X of each blade is fin-shaped (comma-shaped) C and longitudinal direction Y is of plate D like a horizontal blade on an excavator. The preferred outer structure of turbine blades 1 is described below.

Wind turbine blade 1 integrally comprises wind receiving side 1a of concave shape, wind streaming side 1b of convex shape located behind wind receiving side 1a, base end 1a1 of wind receiving side 1a, base end 1b1 of wind streaming side 1b, and connecting side 1c. The preferred structure, combining wind receiving side 1a, wind streaming side 1b and connecting side c is described below.

Wind receiving side 1a integrally comprises base section 100 located near blade core 1d and straightly extending in parabolic direction Z and slanting upward, and base concave-shaped wind receiving section 101, like a sheer cliff that is sunken at a sharp angle from the free end of base section 100, and concave-shaped wind receiving section 102 that is connected to base concave-shaped wind receiving section 101 and extending toward the end of radiation direction Z and forming an inverted parabolic curve regarding reference line A of wind turbine blade 1.

On the other hand, wind streaming side 1b of convex-shaped wind streaming section 103 extends toward the end of radiation direction Z that gently and sequentially bulges regarding reference line A of wind turbine blade 1.

Connecting side 1c comprises concave-shaped connecting section 104 extending toward base ends 1a1 and 1b1 and forming an inverted parabolic curve regarding reference line B between the bases of wind receiving side 1a and wind streaming side 1B.

Wind turbine blade 1 is preferably set of a total of at least three blades (i.e. three or four blades are preferably required, yet the four-blade type is described here) within the frame of wind-driven electricity generator E. The preferred example is described below.

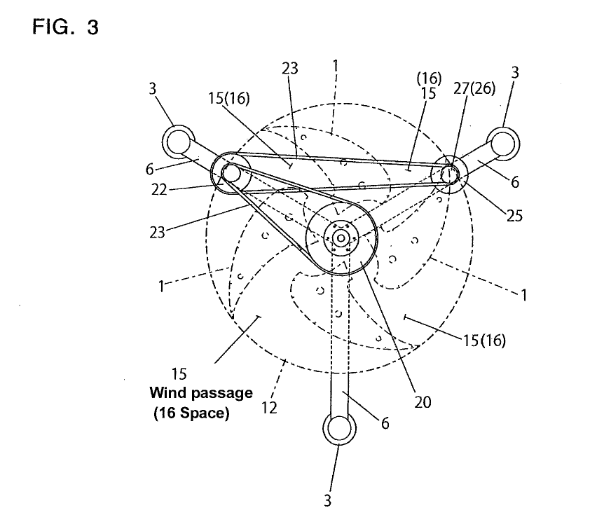

To make the frame of the wind-driven electricity generator, firstly at least three pillars (preferably, three or four pillars should be used) are vertically provided and evenly spaced apart on the base 40. A top joist 5 and a bottom joist 6 are supportively provided on the space between the three pillars 3. A bearing 7 is provided in the center of the bottom joist 6 to vertically set the main shaft 8 therein. Another bearing 10 is provided in the center of the top joist 5 to vertically set a countershaft 11 therein. A bottom plate 12 is horizontally placed upon the main shaft 8, and a top plate 13 is horizontally placed beneath the countershaft 11. The top and the bottom plates are rotatably provided on the shafts. Four wind turbine blades 1, as shown in FIG. 3, are placed within the space between the top plate 13 and the bottom plate 12, and four wind passages 15 are made between the turbine blades 1. In one example of the generator, a large pulley 20 is attached to the main shaft 8, a belt 21 is placed on the large pulley 20 to transmit the power to a deputy pulley 22 provided within the frame. Then, a belt 23 is placed on the deputy pulley 22 to transmit the power to a small pulley 27 (an input axis 26) attached to the electricity generator 25 within the frame. Through this power transmission system, electricity is generated by the electricity generator 25, and such electricity is then stored in the storage battery to be used, sold or the like. The generator disclosed above is but one example. An alternative way (not shown in the drawings) is available by using a continuously variable transmission (CVT), so that the structure, installation and handling or the like of the generator is simplified to secure consistent performance and efficiently to generate electricity.

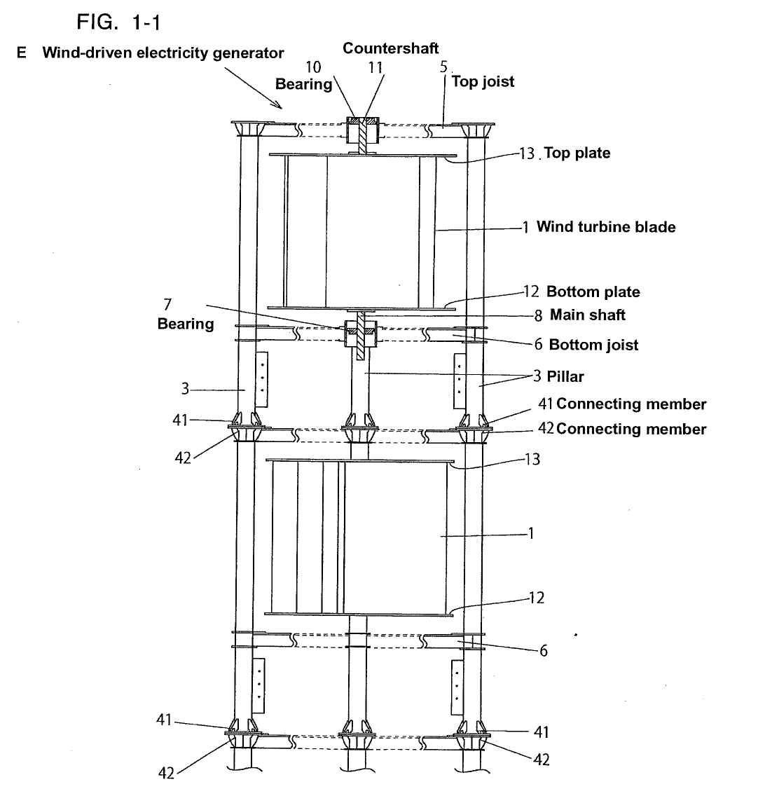

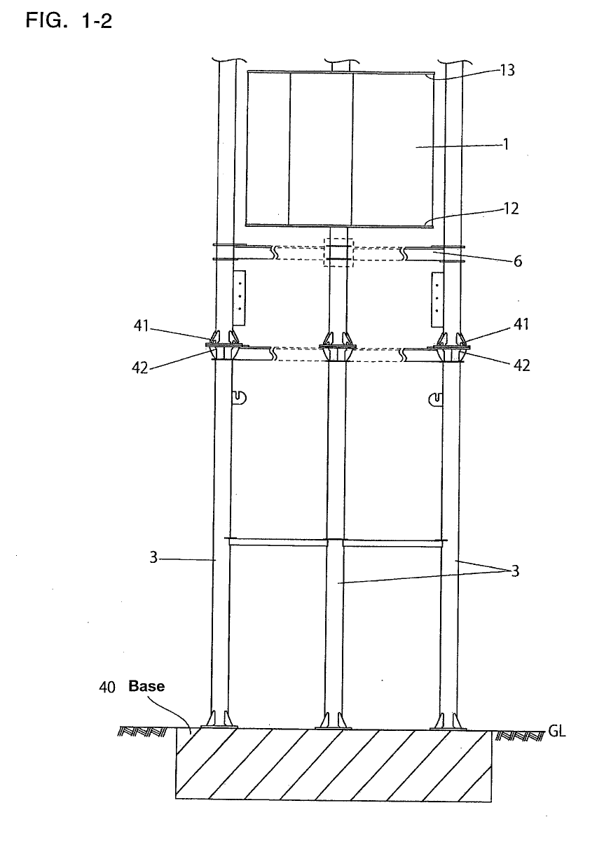

According to the rotation processes of 1 to 3, as shown in FIGS. 7-1 to 7-3, the streaming of wind against the turbine blades 1, the rotation of the blades 1, and the generation of electricity is described below.

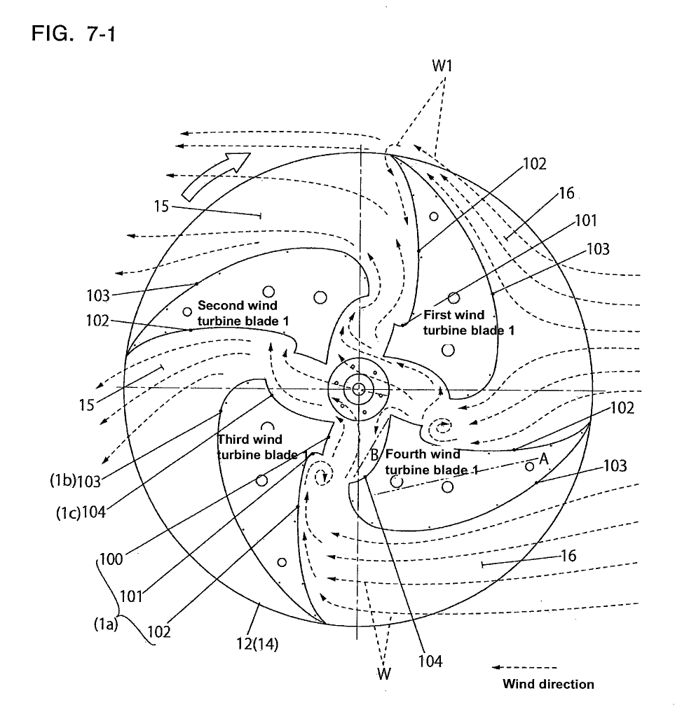

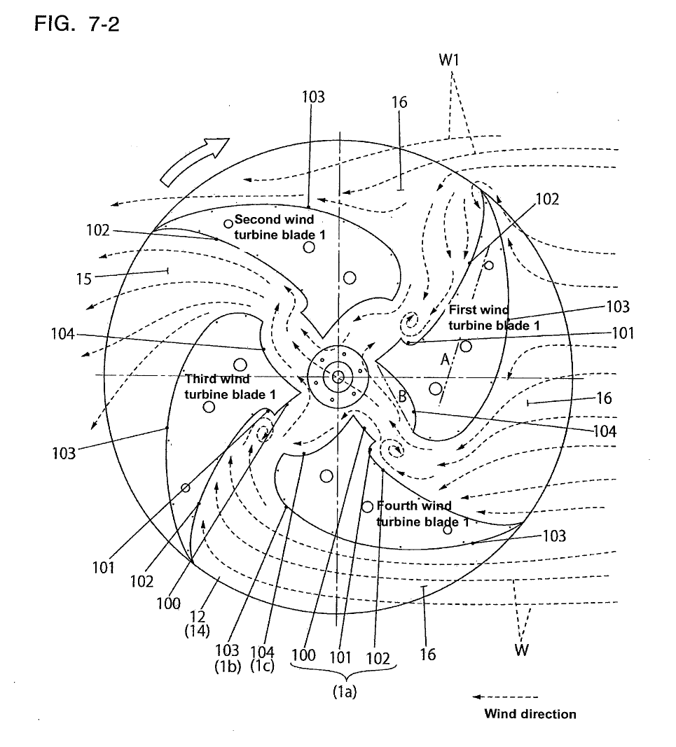

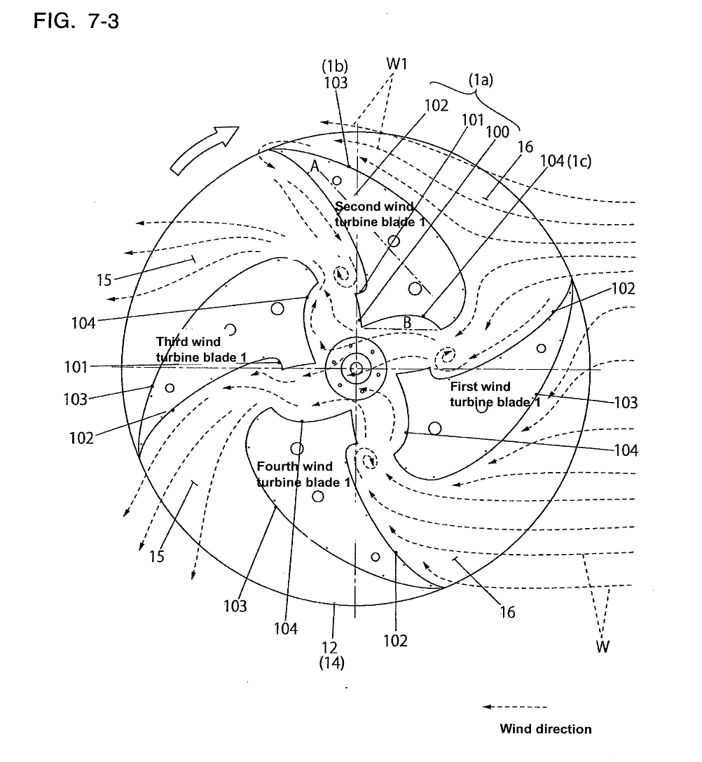

In FIG. 7-1, four turbine blades are vertically provided. When the natural wind W (hereinafter, wind W) pushes against the convex-shaped wind streaming section 103 of the first turbine blade 1, the wind W divides almost in half. The wind W pushing against the base section of the convex-shaped wind streaming section 103 then reaches the concave-shaped wind receiving section 102 of the fourth turbine blade 1 and at the same time joins the wind W streaming along the concave-shaped wind receiving section 102, so as to make a whirling jet against the deep concave of the base concave-shaped wind receiving section 101, thus whirling the fourth turbine blade 1 into a clockwise direction. Such wind power functions as the certain part of the blade rotation process 1. On the other hand, the wind W pushing against the end of the concave-shaped wind streaming section 103 of the first turbine blade 1 negatively acts against the clockwise direction. However, the wind W is divided in half and smoothly streams along the convex-shaped (bulged) surface. Therefore, such wind does not hinder the blade from rotating smoothly. Also, the wind W streams toward the end of the first turbine blade 1, and at the same time the concave-shaped wind receiving section 102 of the first turbine blade 1 receives no load (negative pressure) to take in the wind W from the convex-shaped wind streaming section to make the wind stream smooth and fast, thus eliminating the aforementioned unfavorable blade rotation. Also, flow passage for the wind W to stream from the convex-shaped wind streaming section 103 of the first turbine blade 1 into the after-mentioned wind passage 15 is secured.

In FIG. 7-1, when the wind W is horizontally received by the concave-shaped wind receiving section 102 of the fourth turbine blade 1, such wind W is also facilitated to join the wind from the convex-shaped wind streaming section 103 of the first turbine blade 1, thus making a whirling jet of air at the base concave-shaped wind receiving section 101 of the fourth wind turbine blade 1. Such a whirling jet pushes against the fourth turbine blade 1 and seemly prevents the wind W, which is received by the concave-shaped wind receiving section 102 of the turbine blade 1, from dispersing, escaping or the like. The wind W that is separated from the whirling jet (i.e. the wind W that has already been used) continuously streams along the base concave-shaped connecting section 104 and the base section 100 of the fourth wind turbine blade 1 to the base concave-shaped connecting section 104 of the second wind turbine blade 1 and then continually along the convex-shaped wind streaming section 103 of the second wind turbine blade 1 and eventually exits the wind passage 15 that surrounds the concave-shaped wind receiving section 102 of the second turbine blade 1 and the base concave-shaped connecting section of the third wind turbine blade 1 and the convex-shaped wind streaming section 103. Therefore, such wind W that has already been used and is now streaming through the wind passage 15 does not prevent the rotation process 1. In other words, the wind W is almost completely used for the rotation of the inventive turbine blades.

In this rotation process 1, the wind W is received by the concave-shaped wind receiving section 102 of the third wind turbine blade 1 so as to push the third wind turbine blade 1 into a clockwise direction. Thus, the third wind turbine blade 1 becomes the main factor in causing the rotation process 1. At this time, the whirling jet of air presses against the base concave-shaped wind receiving section 101 of the third wind turbine blade 1, thus preventing the wind W to stream along the concave-shaped wind receiving section 101 of the third wind turbine blade 1 and dispersing, escaping or the like, thus making it possible to obtain the power to press the third wind turbine blade (in a clockwise direction). Therefore, efficient rotation (of the blades) by the power of wind W is effectively done.

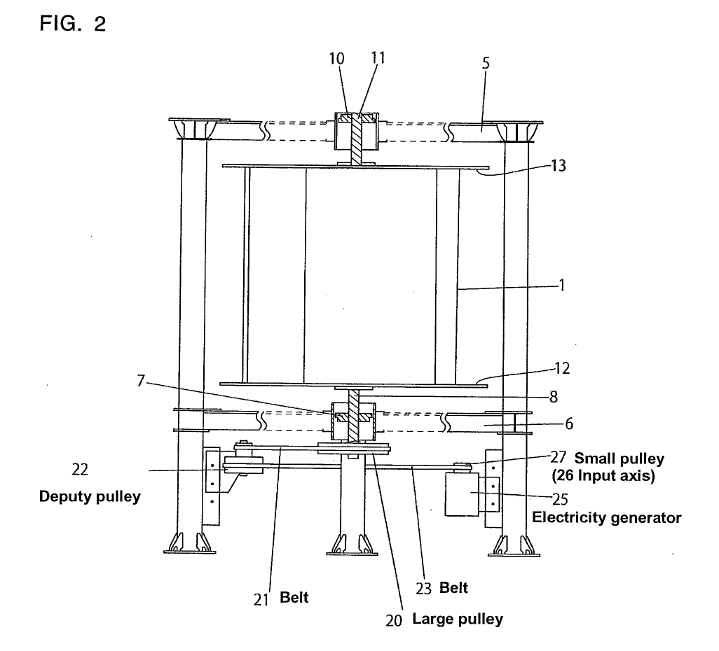

Next, in FIG. 7-2, when the wind W pushes against the convex-shaped wind streaming section 103 of the slanted first wind turbine blade 1, most of it streams down to the base section of the blade, and its power pushes the base section of the convex-shaped wind streaming section 103 of the third wind turbine blade 1 into a clockwise direction. Such power functions as a certain part of the rotation process 2. Also, the wind W streaming along the convex-shaped wind streaming section 103 of the first wind turbine blade reaches the concave-shaped wind receiving section 102 of the fourth wind turbine blade 1, thereby joining the wind W streaming along the concave-shaped wind receiving section 102, thus forming a whirling jet of air at the base concave-shaped wind receiving section 101, which makes it possible to press the fourth wind turbine blade 1 into a clockwise direction. Such power functions as another part of rotation process 2. Some of the used wind W from the whirling jet of air made at the first and fourth wind turbine blades is released smoothly through the wind passage 15, since the wind passage 15 is now of negative pressure.

In FIG. 7-2, the wind W is seen pushing the concave-shaped wind receiving section 102 of the fourth turbine blade 1, thus whirling the third wind turbine blade 1 into a clockwise direction. Thus, the fourth wind turbine blade 1 becomes the main factor for the rotation process 2 of the blade. Also, the wind W streaming along the convex-shaped wind streaming section 103 of the fourth wind turbine blade 1 is seen pushing the concave-shaped wind receiving section 102 of the third wind turbine blade 1, thus whirling the third wind turbine blade 1 into a clockwise direction, thus factoring mainly in the rotation process 2 of the blade. The wind W received by the concave-shaped wind receiving section 102 of the third wind turbine blade 1 becomes a whirling jet of air at the base concave-shaped wind receiving section 101 of the fourth wind turbine blade 1, thus preventing the wind W received by the concave-shaped wind receiving section 102 of the third wind turbine blade 1 from dispersing, escaping or the like. Therefore, such wind pushing power is fully used.

As described above, the wind W, which has already been used continuously, passes through the wind passage 15 and streams along the concave-shaped connecting section 104 of the third wind turbine blade 1 and eventually exiting the turbine through the concave-shaped wind receiving section 102 of the second wind turbine blade 1. Also, the wind W, which is streaming through the wind passage 15 between the concave-shaped connecting section 104 of the fourth wind turbine blade 1 and the base section 100 of the third wind turbine blade 1, continuously streams through the wind passage 15 between the base section 100 of the second wind turbine blade 1 and the concave-shaped connecting section 104 of the third wind turbine blade 1. The wind stream is similar to that of the aforementioned way.

On the other hand, the wind W reaching the concave-shaped wind streaming section 103 of the second turbine blade 1 negatively acts against the rotation of the blade, however, the wind W is divided in half and smoothly streams along the convex-shaped (bulged) surface, therefore, such wind does not hinder the blade from rotating smoothly. On the other hand, the wind W pushing against the concave-shaped wind streaming section 103 of the second turbine blade 1 negatively acts against the rotation of the blade. Yet, the wind W is divided in half and smoothly streams along the convex-shaped surface, so such wind does not hinder the blade from rotating smoothly. This mechanism is a result of a synergetic effect made by the convex-shaped surface of the blades, by the angle provided between the second turbine blade 1 and the top plate 13 as well as the bottom plate 12, and by the end of the blades positioned at the edges of the top and bottom plates 13, 12. (The same mechanism is applied to the first, third and fourth wind turbine blades)

As described above, the rotation process 2 is the basic movement to maximize the rotary power of the blade.

In FIG. 7-3, it is seen that when the wind W pushes against the convex-shaped wind streaming section 103 of the second turbine blade 1 that is almost vertically positioned, the wind W is divided almost in half toward the end of the base section of the blade 1. The wind W pushing against the base section of the convex-shaped wind streaming section 103 reaches the concave-shaped wind receiving section 102 of the first turbine blade 1 and at the same time joins the wind W streaming along the concave-shaped wind receiving section 102, so as to make a whirling jet against the deep concave of the base concave-shaped wind receiving section 101, thus whirling the first turbine blade 1 into a clockwise direction. Such wind power functions as a certain part of the rotation process 3. On the other hand, the wind W that is pushing against the end of the concave-shaped wind streaming section 103 of the second turbine blade 1 negatively acts against the clockwise direction. However, the wind W is divided in half and smoothly streams along the convex-shaped (bulged) surface. Therefore, such wind does not hinder the blade from rotating smoothly. Also, the wind W streams toward the end of the second turbine blade 1, and at the same time the concave-shaped wind receiving section 102 of the first turbine blade 1 receives no load (negative pressure) to take in the wind W from the convex-shaped wind streaming section 103, which makes the wind stream smooth and fast, thus eliminating the aforementioned interference of the rotation of the blades. Also, the flow passage for the wind W to stream from the convex-shaped wind streaming section 103 of the second turbine blade 1 into the wind passage 15 is secured.

In FIG. 7-3, when the wind W pushes against the concave-shaped wind receiving section 102 of the first turbine blade 1 that is slantly positioned, such wind W is also facilitated to join the wind from the convex-shaped wind streaming section 103 of the second turbine blade 1, thus forming a whirling jet of air at the base concave-shaped wind receiving section 101 of the first wind turbine blade 1. Such a whirling jet powerfully presses the first turbine blade 1, thus seemingly preventing the wind W that is received by the concave-shaped wind receiving section 102 of the first turbine blade 1 from dispersing, escaping or the like. The wind W that is separated from the whirling jet (i.e. the wind W already used) continuously streams along the base concave-shaped connecting section 104 and along the base section 100 of the first wind turbine blade 1 to the base concave-shaped connecting section 104 of the third wind turbine blade 1 and then continually along the convex-shaped wind streaming section 103 of the third wind turbine blade 1 and eventually exits the wind passage 15 that surrounds the concave-shaped wind receiving section 102 of the third turbine blade 1 and the base concave-shaped connecting section 104 and convex-shaped wind streaming section 103 of the fourth wind turbine blade 1. Therefore, such wind W that has already been used and now streaming through the wind passage 15 does not prevent the rotation process 1. In other words, the wind W is almost completely used for the rotation of the inventive turbine blades.

In this rotation process 3, the wind W pushes against the concave-shaped wind receiving section 102 of the fourth wind turbine blade 1, thus whirling the fourth wind turbine blade 1 into a clockwise direction. Thus, the third wind turbine blade 1 becomes a main factor in causing the rotation process 1. At this time, the whirling jet of air is made at the base concave-shaped wind receiving section 101 of the fourth wind turbine blade 1. This whirling jet prevents the wind W streaming along the concave-shaped wind receiving section 101 of the fourth wind turbine blade 1 from dispersing, escaping or the like, thus making it possible to obtain the power to push the fourth wind turbine blade (in a clockwise direction). Therefore, efficient rotation (of the blades) by the power of wind W is effectively done.

As described above, by the continual rotation of the wind turbine blades comprising the basic structure of the first to fourth turbine blades 1, together with the wind W, electricity is constantly generated by the electricity generator 25 and its actuation system. Each rotation process as described above is characterized in that a mask-shaped space 16 is made between the top plate and the top surface of the turbine blade 1 and between the bottom plate and the bottom surface of the turbine blade. Then, each space 16 is negatively pressured to take in the wind W1 from outside of the generator, thus functioning as a lift-type turbine blade 1 as well. Eventually, the wind W1 in the vicinity of the inventive wind-driven electricity generator E is also efficiently used. Also, such a wind take-in function greatly complies with the basic structure of the turbine blade 1 and produces a synergetic effect by the wind passage 15. The electricity generated here is also used, as described above. In this invention, the wind W is not cut. Thus, no noise nor low frequency waves are made, thus providing an eco-friendly electricity generator E. Also, only a certain velocity of wind W is used. Thus, the generator will be less damaged in a strong wind, thus making it possible to use the generator for a long time, and to thin or reduce the weight of the top and bottom plates or the like, as well, so as to cut the costs, which will result in encouraging a broad use of this electricity generator.

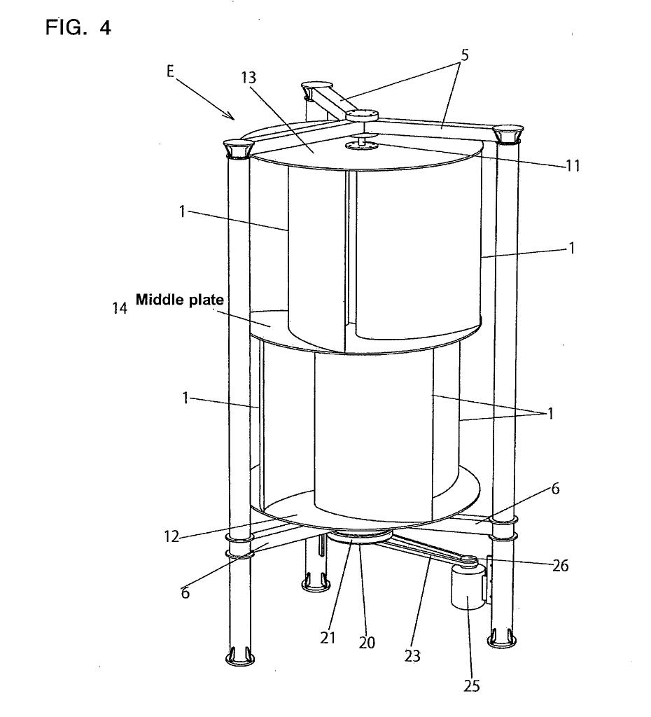

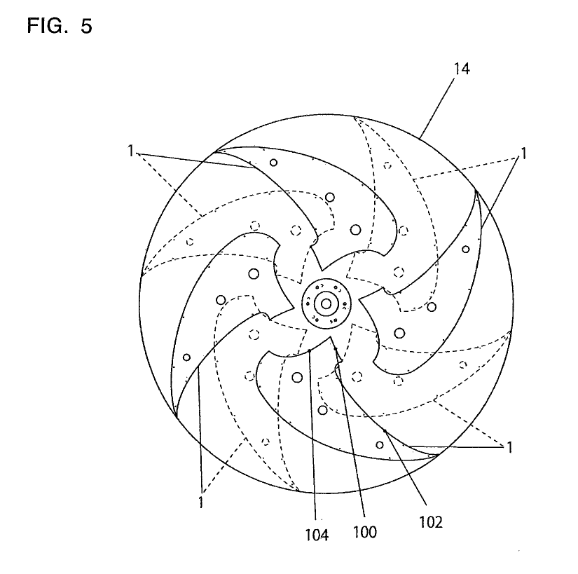

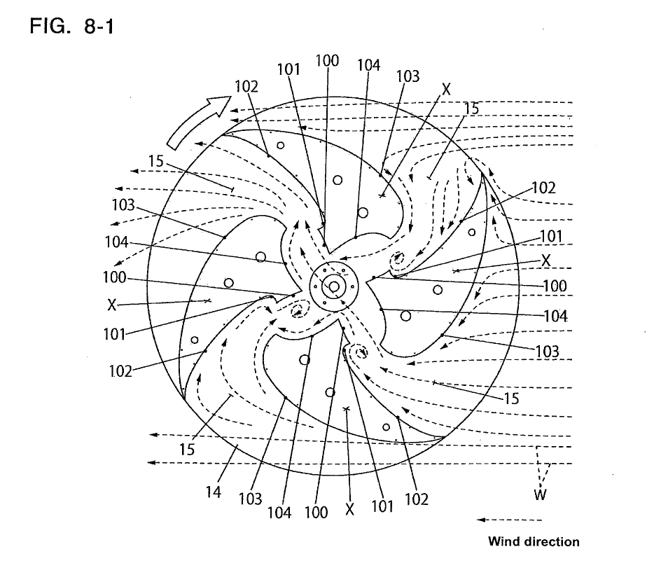

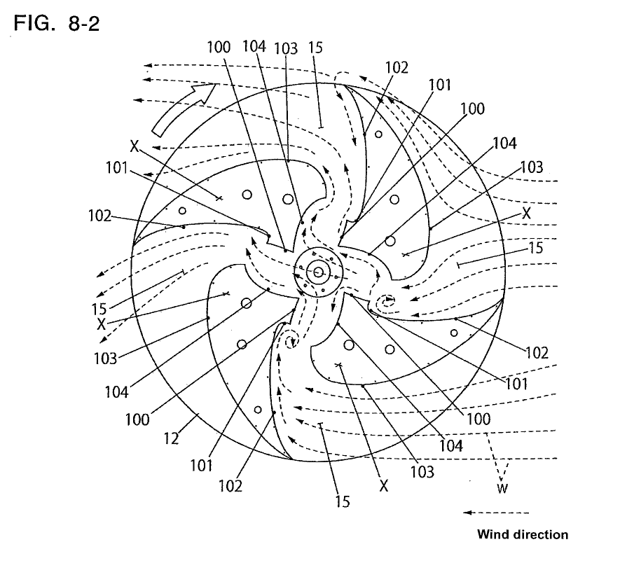

As shown in FIGS. 4 and 5, the turbine blades 1 are set above and below each other and in different sync to each other. For example, the turbine blades 1 as shown in FIG. 8-1 are set between the top plate 13 and the middle plate 14 and are in different sync to those set between the middle plate 14 and the bottom plate 12, as shown in FIG. 8-2, being, for example, approximately 45 degrees different in sync, thus letting the wind W be gently, efficiently and continuously captured by each turn of the turbine blades 1, as described in FIGS. 7-1 to 7-3. Also, referred to in FIGS. 7-1 to 7-3 is the condition and motion of the receiving wind W, and of the generation of electricity and of the noise or the like. In this second embodiment, the preferable difference in phase to maximize the effect (of generating electricity) is approximately 45 degrees, but not be limited to that difference. The middle plate 14 is set between the top and bottom turbine blades 1 to let them rotate simultaneously.

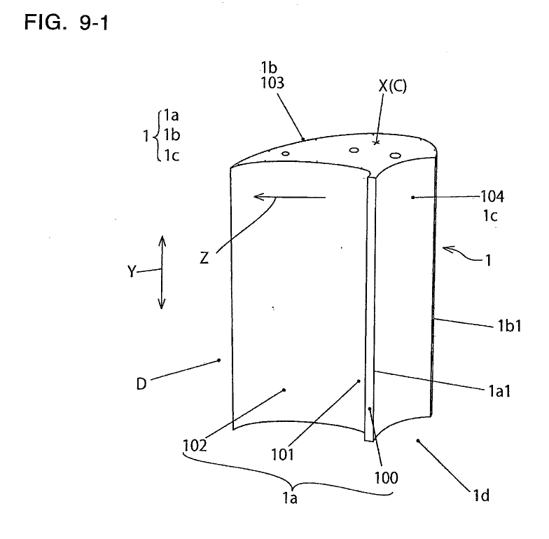

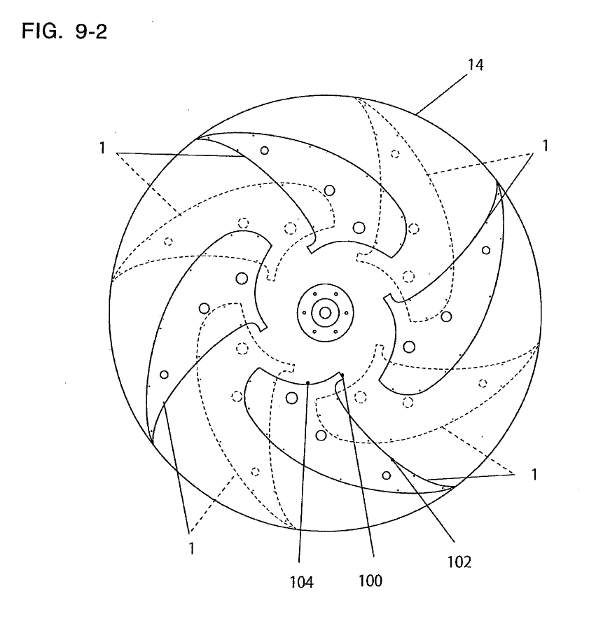

In FIGS. 9-1 and 9-2, the turbine blades 1 are shown having a structure of which the base section 100 is narrow and the concave-shaped connecting section 104 extends to make the wind W steam smoothly and quickly to exit the turbine, thus letting the turbine blades 1 turn efficiently in low-velocity wind. Referring to the second embodiment, FIG. 9-2 shows the top and bottom turbine blades to be in different synce and adhering to the other features of the aforementioned embodiments.

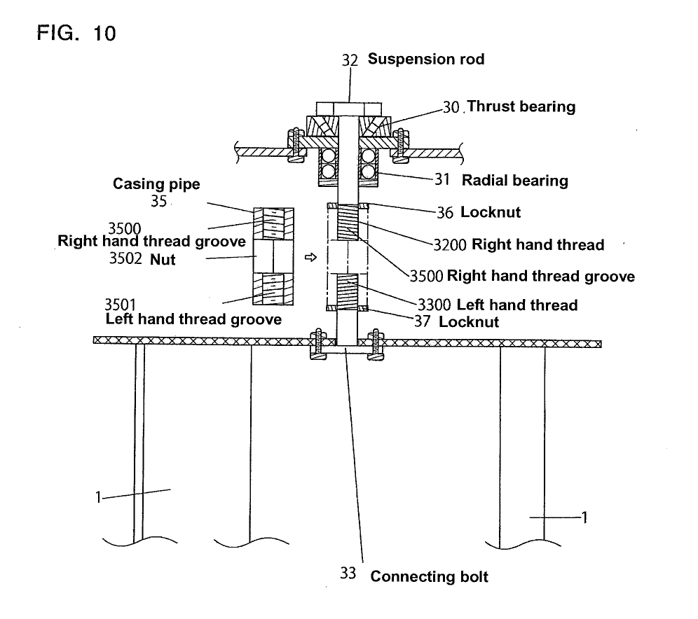

The suspension rod 32 is supportively provided through the thrust bearing 30 or/and the radial thrust between the top joist 5. FIG. 10 shows one example of a suspension system for the top turbine blades 1 of the first and second embodiments. The suspension rod 32 is supportively provided on the top joist 5 through the thrust bearing 30 or/and the radial thrust. The right-hand thread 3200 on the bottom part of the suspension rod 32 is attached to the left-hand thread 3300 on the top part of the connecting bolt that is inserted vertically into the top plate 13, by a casing pipe 35 having a right-hand thread groove 3500 and a left-hand thread groove 3501. Of this structure, the nut 3502 of the casing pipe 35 is tighten to pull the connecting bolt 33 up to near the suspension rod 32, thus firmly suspending the top turbine blades 1. Suspending the top turbine blades 1 through the thrust bearing 30 reduces stress on the bottom turbine blades 1 and/or the main shaft 8 and lets the top and bottom turbine blades 1 rotate even in a low-velocity wind and reduces the size of the generator equipment and the cost of materials or the like. Also, the bottom turbine blades 1 is supportively provided on the main shaft 8 that is set on the bottom joist 6 as described above. The top turbine blades 1 fixed to the top plate 13 is integrated with the bottom turbine blades 1 fixed to the bottom plate 12 by the middle plate 14 fixed in between. The top plate 13 and bottom plate 12 rotate in sync. Other features comply with the aforementioned second embodiment. This suspension system can be used also for other embodiments. After tightening the casing pipe 35 by the locknuts 36 and 37, the suspension rod 32 and connecting bolt 33 are tightly joined.

FIGS. 1-1 and 1-2 show a wind-driven electricity generator E of which its three pillars 3 are attached together by the top joist 5 and the bottom joist 6 upon the base 40, with four turbine blades 1 installed upon the main shaft 8 and the countershaft 11 between the top plate 13 and bottom plate 12. In this example, a three-story frame is set upon the base 40, with a set of turbine blades provided respectively on the second and third stories. To get more electricity, it is possible to mount more turbine blades upward upon this same three-pillar frame. In that case, additional top and bottom pillars can be fixed together by connecting members 41 and 42 and other fixing tools that are not shown in the drawings. Also, each wind-driven electricity generator E has just one electricity generator 25 (including the large pulley 20 or the like) as shown in FIG. 2. FIGS. 1-1 and 1-2 show a plurality of the wind-driven electricity generator E vertically mounted, though it has just one electricity generator 25.

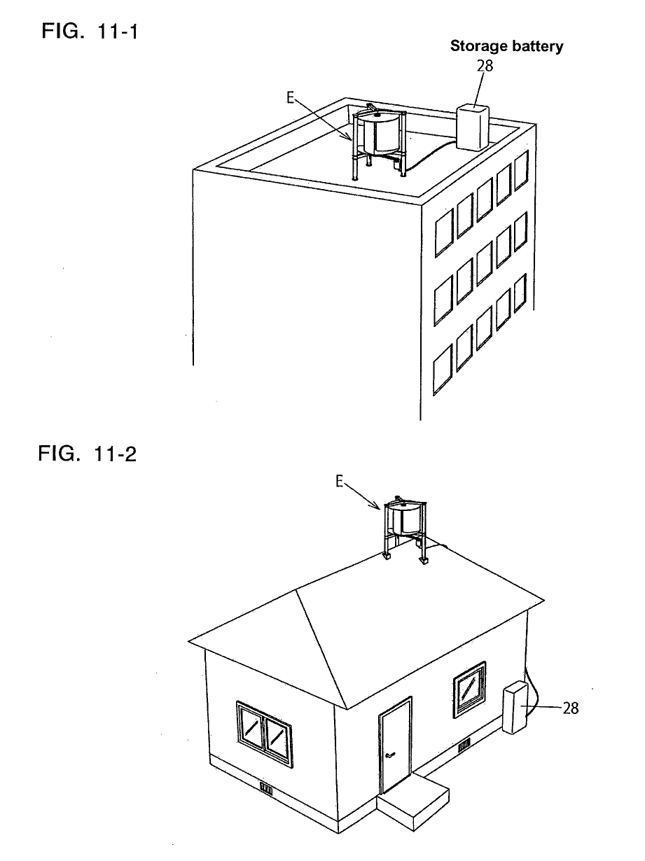

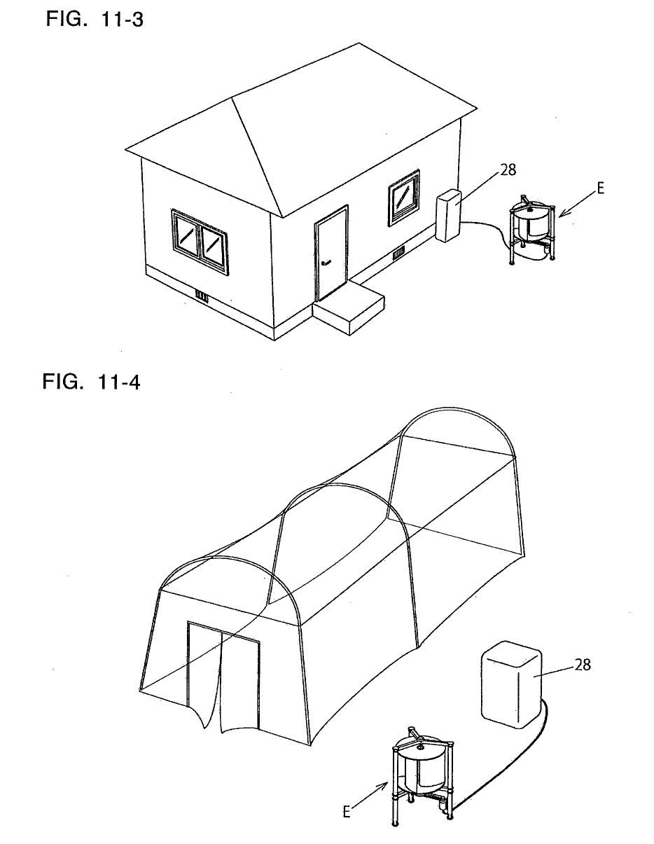

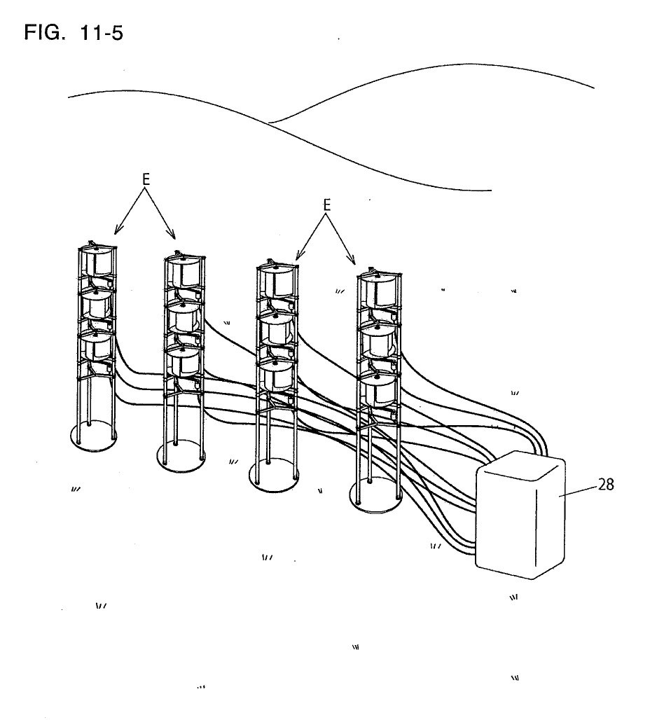

FIGS. 11-1 to 11-5 show the preferable (but not limited) examples of where to install the wind-driven electricity generator E.

### EXPLANATION OF THE ALPHANUMERIC REFERENCES

1 Wind turbine blade
1a Wind receiving side
1a1 Base end
1b Wind streaming side
1b1 Base end
1c Connecting side
1d Blade core
100 Base section
101 Base concave-shaped wind receiving section
102 Concave-shaped wind receiving section
103 Convex-shaped wind streaming section
104 Concave-shaped connecting section
3 Pillar
5 Top joist
6 Bottom joist
7 Bearing
8 Main shaft
10 Bearing
11 Countershaft
12 Bottom plate
13 Top plate
14 Middle plate
15 Wind passage
16 Space
20 Large pulley
21 Belt
22 Deputy pulley
23 Belt
25 Electricity generator
26 Input axis
27 Small pulley
28 Storage battery
30 Thrust bearing
31 Radial bearing
32 Suspension rod
3200 Right-hand thread
33 Connecting bolt
3300 Left-hand thread
35 Casing pipe
3500 Right-hand thread groove
3501 Left-hand thread groove
3502 Nut
36 Locknut
37 Locknut
40 Base
41 Connecting member
42 Connecting member
A Reference line
B Reference line
C Fin-shaped surface
D Plate-like surface
E Wind-driven electricity generator
W Wind
W1 Wind
X End face
Y Longitudinal direction
Z Radiation direction

What is claimed is:

1. Drag-type wind turbine blades for a wind-driven electricity generator, vertically provided between at least two plates provided in the air of which the wind turbine blades of a plate-like structure and a fin-shaped surface comprising a wind receiving side to receive wind, and a wind streaming side located on the back of the wind receiving side, and a base end of the wind receiving side and a connecting side to connect the base end of the wind streaming side, characterized in that the wind receiving side comprises a base section, and a base concave-shaped wind receiving section that is sunken at a sharp angle from the free end of the base section, and an concave-shaped wind receiving section in the shape of an inverse parabola extending in the radiation direction, and the wind streaming side having a convex-shaped wind streaming section that is gently formed in the shape of a parabola extending from the base section toward the end of the radiation direction, and the connecting side comprising a concave-shaped connecting section in the shape of an inverse parabola extending toward both base ends.

2. Drag-type wind turbine blades for a wind-driven electricity generator according to claim 1, characterized in that a concave condition of the base concave-shaped wind receiving section of the blades, a caving direction of the concave-shape wind receiving section and a bulging direction of the convex-shaped wind receiving section of the blades are determined based on reference line A provided on the top surface of the wind turbine blade.

3. Drag-type wind turbine blades for a wind-driven electricity generator according to claim 1, characterized in that a caving direction of the concave-shaped connecting section of the blades is determined based on reference line B provided between the base ends of the wind receiving side and of the wind streaming side.

4. A wind-driven electricity generator having an outer framework of which a plurality of pillars are vertically provided on the base, with joists being provided at the top and bottom on the pillars at a certain distance apart, and a main shaft being supportively provided by a bearing on the bottom joist whilst a countershaft is supportively provided by a bearing, characterized in that a top and bottom plate are respectively provided on the main shaft and countershaft, and between them a plurality of plate-like wind turbine blades of a fin-shaped surface, integrally comprising a wind receiving side to receive the wind, and a wind streaming side located on the back of the wind receiving side, and a base end of the wind receiving side and a connecting side to connect the base end of the wind streaming side, are vertically provided, wherein wind passages (1 to n) are provided in a space formed by a certain part of the peripheral wall consisting of the wind receiving side and connecting side of the first to nth turbine blades and a certain part of the peripheral wall consisting of the wind receiving side and connecting side of the fourth to nth turbine blades and in a space formed by an entire peripheral wall consisting of the wind receiving side and the wind streaming side and the connecting side of the second to nth turbine blades and an entire peripheral wall consisting of the wind receiving side and the wind streaming side and the connecting side of the third to nth turbine blades.

5. A wind-driven electricity generator according to claim 4, characterized in that a large pulley is attached to a main shaft, with a belt fitted on the large pulley to connect it to a deputy pulley, and with a belt fitted on the deputy pulley to connect it to a small pulley provided on the input axis of the generator.

6. A wind-driven electricity generator according to claim 4, characterized in that a middle plate is provided between the top plate and the bottom plate, wherein a plurality of bottom wind turbine blades and wind passages are provided between the bottom plate and the middle plate, and a plurality of top wind turbine blades and wind passages are provided between the middle plate and the top plate.

7. A wind-driven electricity generator according to claim 6, characterized in that a plurality of top and bottom wind turbine blades and respective wind passages are provided between the top and bottom and a middle plates, wherein the top and bottom wind turbine blades and wind passages are in different rotational phase.

8. A wind-driven electricity generator according to claim 4, characterized in that the top wind turbine blades are supportively hung from the top plate, the top wind turbine blades are connected to the bottom wind turbine blades through the middle plate, and the bottom wind turbine blades are provided on the bottom plate that is fixed to the main shaft provided on the bottom joist.
